(19) United States
(12) Patent Application Publication
(10) Pub. No.: US 2001/0022204 A1
(43) Pub. Date: Sep. 20, 2001

(54) Apparatus and method for filling dispensers with a premixed liquid chemical

(76) Inventors: Walter F. Klima JR., Travelers Rest, SC (US); William L. Klima, Stafford, VA (US)

Correspondence Address: William L. KLIMA, Esq., LAW OFFICES OF WILLIAM L. KLIMA, P.L.C., P.O. Box 2855, Stafford, VA, 22555-2855, US

(21) Appl. No.: 09/775,609

(22) Filed: Feb. 5, 2001

Related U.S. Application Data
(63) Continuation-in-part of application No. 09/066,951, filed on Apr. 28, 1998, now abandoned.

(51) Int. Cl. B65B 1/04; B67C 3/02; B65B 3/04

(52) U.S. Cl. 141/103

(57) ABSTRACT

An apparatus and method for filling spray bottle dispensers with premixed, ready-to-use liquid chemical includes a spray bottle dispenser with two separate necks. A sprayhead is connected to the first neck and a cap closes the second neck. The premixed, ready-to-use liquid chemical enters the spray bottle dispenser through the second neck. A check valve may be placed in the second neck or in the cap. When placed in the cap, the spray bottle dispenser may be refilled without removing the cap.

### RELATED APPLICATION

This is a continuation-in-part application of U.S. Patent Application entitled “Apparatus and Method for Filling Dispensers with a Premixed Liquid Chemical”, Ser. No. 09/066,951, filed on Apr. 28, 1998, fully incorporated herein by reference.

### FIELD OF THE INVENTION

The present invention relates in general to refillable dispensers, and, in particular, to refillable spray bottle dispensers. Specifically, the present invention is directed to a method and apparatus for filling spray bottle dispensers with a premixed, ready-to-use liquid chemical.

### BACKGROUND OF THE INVENTION

There are numerous hand held spray devices known in the prior art. The use of spray bottles for dispensing chemical reagents ( for example, cleaners, soaps, insecticides, hair spray, etc.) is well known.

Spray bottle dispensers generally include a liquid containing bottle, a pump-type sprayhead threadably connected to the bottle and a downtube connected to the sprayhead and extending into the liquid containing bottle.

In general, commercial users of spray bottle dispensers reuse the dispensers by refilling the spray bottles with the particular chemical being used. Reusing the dispensers is much more economical than buying a new dispenser filled with liquid each time the liquid in a spray bottle is depleted. There are, however, problems associated with refilling the spray bottle dispensers.

For example, to refill a bottle, the sprayhead must be unscrewed and removed from the bottle. Because the downtube is connected to the sprayhead, the sprayhead with downtube attached must be completely removed from the bottle. Of course, because some liquid chemical remains on the downtube and sprayhead, sprinkling and splattering of the liquid on the persons refilling the bottle and on the surrounding area is inevitable. Depending on the particular chemical being used, such contact may be hazardous and necessitate expensive and time consuming precautionary measures. Additionally, it is time consuming to remove the sprayhead and downtube each time the bottle needs to be refilled.

Some conventional methods of refilling require mixing of a chemical concentrate with water. In these methods, chemical concentrate is poured into the spray bottle and then water is added. A disadvantage of mixing is that the persons refilling the bottles may not mix the correct amounts of chemical concentrate and water. Furthermore, contact with chemical concentrate can be much more hazardous to people and the surrounding environment than contact with a premixed, diluted chemical. Also, it can be difficult to add water to the spray bottle from a faucet in a sink because the spray bottle dispenser is too tall to allow filling of the water to the proper level or the spray bottle dispenser may be too tall to fit in the sink at all.

The apparatus and method of the present invention uses a spray bottle dispenser having at least two necks. U.S. patents related to two neck spray bottle dispensers include U.S. Pat. No. 5,439,141 to Clark et al; U.S. Pat. No. 4,705,191 to Iztel et al; and U.S. Pat. No. 4,832,230 to Janowitz. These three U.S. patents are hereby expressly incorporated by reference.

### SUMMARY OF THE INVENTION

It is an object of the present invention to provide an apparatus and method for refilling spray bottle dispensers wherein the dispensers are refilled with a premixed, ready-to-use liquid chemical.

It is another object of the present invention to provide an apparatus and method for refilling spray bottle dispensers wherein it is unnecessary to remove the sprayhead and attached downtube.

It is a further object of the present invention to provide an apparatus and method for refilling spray bottle dispensers that is less time consuming than the prior art.

It is yet another object of the present invention to provide an apparatus and method for refilling spray bottle dispensers that does not require the person refilling the dispensers to measure and mix chemicals.

It is still another object of the present invention to provide an apparatus and method for refilling spray bottle dispensers wherein the dispensers may be refilled without removing a cap from the spray bottle.

A still further object of the invention is to provide an apparatus and method for refilling spray bottle dispensers with a plurality of different types of premixed, ready-to-use liquid chemicals.

These and other objects of the invention are achieved by an apparatus for filling spray bottle dispensers with premixed, ready-to-use liquid chemical, comprising: a spray bottle dispenser, the spray bottle dispenser comprising a bottle portion having first and second neck portions and a liquid containing portion; a sprayhead portion connected to the first neck portion; a downtube connected to the sprayhead portion and extending into the liquid containing portion; and a cap for closing the second neck portion; the apparatus further comprising means for supplying at least one type of premixed, ready-to-use liquid chemical for filling the spray bottle dispenser wherein the premixed, ready-to-use liquid chemical enters the spray bottle dispenser through the second neck portion.

Preferably, when the spray bottle dispenser is in the upright position, a longitudinal axis of the second neck is substantially vertical.

In one embodiment, the apparatus further comprises a check valve in the second neck portion.

In a preferred embodiment, the means for supplying comprises at least one container containing the at least one type of premixed, ready-to-use liquid chemical.

In another preferred embodiment, the means for supplying comprises a plurality of containers containing a plurality of chemical concentrates, respectively; a water supply; a manifold connected to the plurality of containers and the water supply, for mixing the chemical concentrates with water to obtain premixed ready-to-use liquid chemicals, the manifold including a shut-off valve for each container; and flexible tubes connected to each shut-off valve.

In yet another preferred embodiment, the cap for closing the second neck portion includes a check valve such that the spray bottle dispenser can be filled by inserting a filler probe through the check valve.

Another aspect of the invention is a method for filling a spray bottle dispenser with premixed, ready-to-use liquid chemical, comprising providing a spray bottle dispenser having first and second necks, a sprayhead connected to the first neck, and a cap for closing the second neck; providing a supply of the premixed, ready-to-use liquid chemical; and dispensing the premixed, ready-to-use liquid chemical into the spray bottle dispenser via the second neck.

In one embodiment of the method, the second neck includes a check valve.

Preferably, the providing step includes providing a plurality of containers containing a plurality of chemical concentrates, respectively; a water supply; a manifold connected to the plurality of containers and the water supply, for mixing the chemical concentrates with water to obtain premixed ready-to-use liquid chemicals, the manifold including a shut-off valve for each container; flexible tubes connected to each shut-off valve; and filler probes connected to each flexible tube.

In a preferred embodiment, the cap for closing the second neck includes a check valve and the dispensing step includes inserting a filler probe through the check valve in the cap.

Further objects, features and advantages of the invention will become apparent from the following detailed description, taken in conjunction with the accompanying drawing.

### BRIEF DESCRIPTION OF THE DRAWINGS

FIG. 1 shows one embodiment of an apparatus for filling spray bottle dispensers with premixed, ready-to-use liquid chemical, according to the invention.

FIGS. 2 and 3 show a second embodiment of an apparatus for filling spray bottle dispensers with premixed, ready-to-use liquid chemical, according to the invention.

FIG. 4 shows a partial cutaway of one embodiment of a cap for the second neck of a spray bottle dispenser according to the invention.

FIG. 5 shows a cross-section of one embodiment of the second neck of a spray bottle dispenser according to the invention.

FIG. 6 shows a cross-section of a second embodiment of a cap for the second neck of a spray bottle dispenser according to the invention.

FIG. 7 is a top view of the check valve of the cap of FIG. 6.

FIG. 8 is a side view of the check valve of FIG. 7.

FIG. 9 is a cross-section of a filler probe according to the invention.

### DETAILED DESCRIPTION OF THE PREFERRED EMBODIMENTS

An apparatus and method for filling spray bottle dispensers with premixed, ready-to-use liquid chemical includes a spray bottle dispenser with first and second necks. A sprayhead is connected to the first neck and a cap closes the second neck. The premixed, ready-to-use liquid chemical enters the spray bottle dispenser through the second neck. A check valve may be placed in the second neck or in the cap that closes the second neck. When a check valve is placed in the cap that closes the second neck, the spray bottle dispenser may be refilled without removing the cap from the second neck.

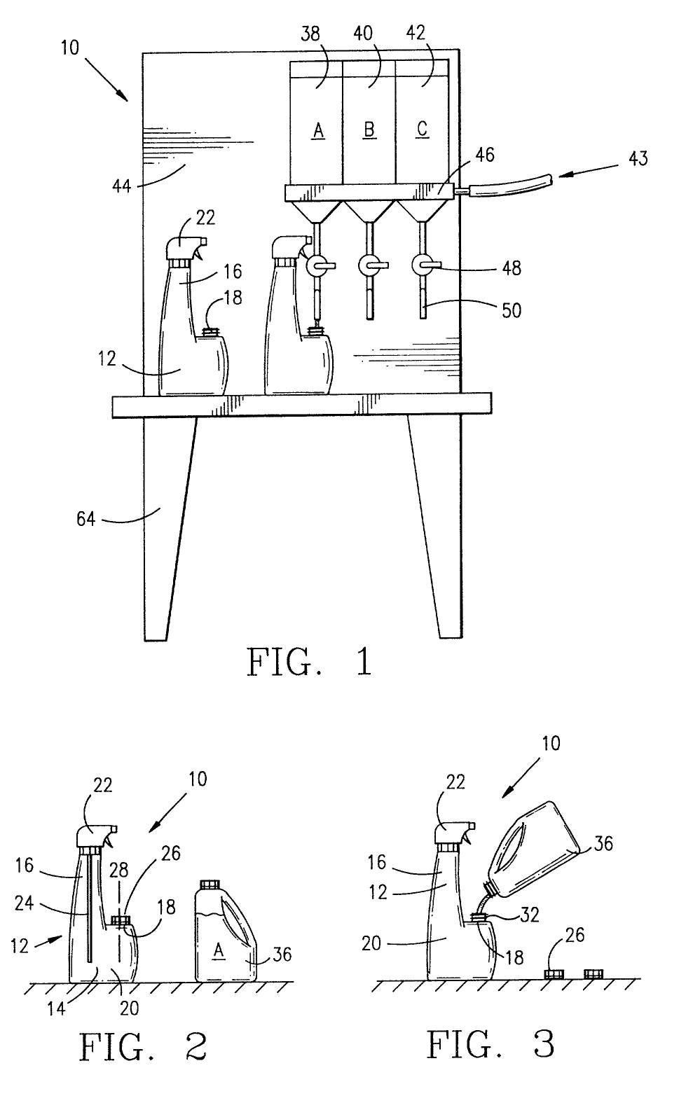

As generally shown in FIGS. 1-3, the present invention is an apparatus 10 for filling spray bottle dispensers with pre-mixed, ready-to-use liquid chemical, comprising a spray bottle dispenser 12 and a means for supplying pre-mixed, ready-to-use liquid chemical for filling the spray bottle dispenser 12.

With reference to the embodiment of FIGS. 2 and 3, the spray bottle dispenser 12 includes a bottle portion 14, first and second neck portions 16, 18 and a liquid containing portion 20. A sprayhead 22 is connected to the first neck 16. The sprayhead 22 is connected to a downtube 24 which extends into the liquid containing portion 20. For clarity, the downtube 24 is shown only in FIG. 2. The sprayhead 22 and downtube 24 may be any of the conventional sprayheads known in the art which will dispense liquid chemical from the liquid containing portion 20 through the sprayhead 22 to the desired area of application.

Preferably, the sprayhead 22 is removably connected to the first neck portion 16 by, for example, threads. When the spray bottle dispenser 12 is in the upright position as shown in FIGS. 1-3, the second neck portion 18 is vertically below the first neck portion 16. Additionally, when the spray bottle dispenser 12 is in the upright position as defined above, a longitudinal axis 28 of the second neck portion 18 is substantially vertical. The vertical orientation of the second neck portion 18 facilitates easy filling of the spray bottle dispenser 12.

The spray bottle dispenser 12 includes a cap 26 for closing the second neck portion 18. In FIG. 4, the left side of cap 26 is cut away. The interior of the cap 26 is preferably internally threaded and the second neck portion 18 includes external threads 32 such that the cap 26 threadably engages the second neck portion 18.

In the embodiment of FIGS. 2 and 3, the means for supplying the pre-mixed, ready-to-use liquid chemical is a container 36 containing premixed liquid chemical A. To refill spray bottle dispenser 12, cap 26 is removed and the premixed liquid chemical A in container 36 is poured into the dispenser 12 through the second neck portion 18. Cap 26 is then replaced on the second neck portion 18. Refilling the dispenser 12 through the second neck portion 18 eliminates the time consuming and potentially hazardous step of removing the sprayhead 22 and downtube 24. By using the premixed liquid chemical A in container 36, the possibility that the person refilling the dispenser 12 will incorrectly mix proportions of chemical concentrate and water is eliminated. Additionally, there is no possibility of contact with the potentially more hazardous chemical concentrate.

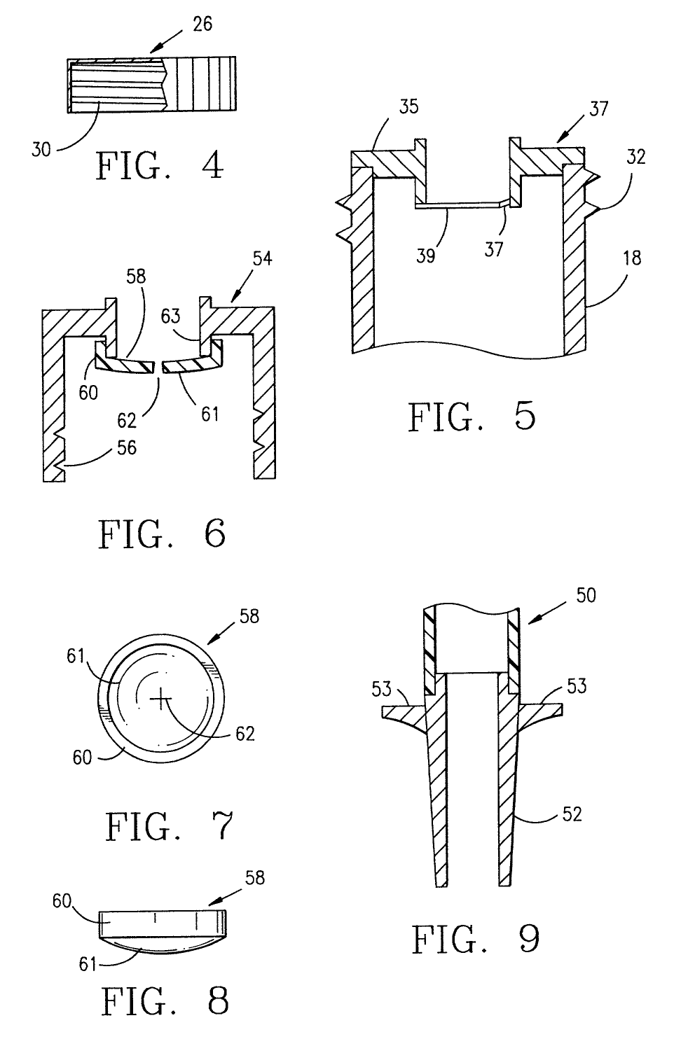

FIG. 5 shows one preferred embodiment of the present invention wherein the spray bottle dispenser 12 with a second neck portion 18 includes at the exterior opening of the second neck a one-way or check valve 34. The purpose of the check valve 34 is to allow the pre-mixed liquid chemical to be poured into the second neck portion 18 to a level vertically above the top of the second neck portion 18 (see FIGS. 1-3). Without the check valve 34 in the second neck portion 18, the dispenser 12 could only be filled to a level corresponding to the top of the second neck portion 18. Therefore, the check valve 34 allows the dispenser 12 to be filled with a greater quantity of liquid chemical. By filling the dispenser 12 with a greater quantity of liquid chemical, the dispenser 12 can be used for a longer period of time before another refill is necessary.

The embodiment of the check valve 34 shown in FIG. 5 includes a body portion 35 that snap fits onto the top of the second neck portion 18. A live hinge 37 connects a flap 39 to the body portion 35. In FIG. 5, the check valve 34 is shown in a closed position. When opened, the flap 39 rotates about the hinge 37 to allow liquid chemical to enter the neck portion 18. Other check valve structures may be substituted for the check valve structure shown in FIG. 5.

In a second embodiment of the invention shown in FIG. 1, the means for supplying the pre-mixed, ready-to-use liquid chemical includes containers 38, 40 and 42 containing chemical concentrates A, B, C, respectively. Preferably, the containers 38, 40, 42 are connected to a manifold 46. The manifold 46 is connected to a water supply 43 and includes, for each of the types of chemical concentrate A, B, C, a respective mixing valve (not shown) wherein the correct amount of chemical concentrate A, B, or C is mixed with the water from the water supply 43 as it flows into the manifold 46. The results of the mixing of the chemical concentrates A, B, C with water in the respective mixing valves are premixed ready-to-use liquid chemicals suitable for filling the spray bottle dispensers 12.

The manifold 46 further includes shut-off valves 48 for each of the containers 38, 40, 42 to regulate the flow of the premixed ready-to-use liquid chemicals from the manifold to the second neck portion 18 of the dispenser 12. Flexible tubes or hoses 50 are connected to the shut-off valves 48. When a shut-off valve 48 is opened, the premixed, ready-to-use liquid chemical flows through the hose or tube 50 into the second neck portion 18 of the dispenser 12 . The second neck portion 18 may also include the check valve 34 previously discussed and shown in FIG. 5, with its attendant advantages. Preferably, the containers 38, 40, 42 are mounted on a structure 44 such that the chemical concentrates A, B, C contained in the containers 38, 40, 42 and the resultant premixed ready-to-use liquid chemicals can be gravity fed into the second neck portion 18 of the spray bottle dispenser 12,

In one preferred embodiment, shown in FIG. 9, the flexible tubes 50 connected at first ends to the shut-off valves 48 are connected at their other ends to filler probes 52. The filler probe 52 is made of brass or a similar material that does not react with the chemical concentrates A, B, C. The filler probe 52 may include a grip 53 for facilitating handling the hose 50 when transferring premixed ready-to-use liquid chemical from the manifold 46 and shut-off valve 48 through the hose 50 to the second neck portion 18 of the dispenser 12. The probe 52 may be used with the second neck portion 18 with or without the check valve 34.

In a most preferred embodiment, as shown in FIGS. 6-8, the probe 52 is used with an alternative embodiment of a cap 54 for the second neck portion 18. The cap 54, shown in cross-section in FIG. 6, includes internal threads 56 for engaging with the external threads 32 of the second neck portion 18. In addition, the cap 54 includes a check valve 58. The check valve 58 comprises an annular section 60 and an internal section 61. The check valve 58 is made of silicon or a similar material. The annular portion 60 grips an annular depending portion 63 of the cap 54 to hold the check valve 58 in place. The internal section 61 includes a cross-hair opening 62 for filling the dispenser 12 with premixed ready-to-use liquid chemical.

In operation, the probe 52 is inserted through the cross-hair 62 to fill the dispenser 12. When the dispenser 12 is filled, the probe 52 is removed through the cross-hair 62 which closes to prevent liquid chemical contained in the dispenser 12 from leaking. A particular advantage of this embodiment is that it is not necessary to remove any cap from the dispenser 12 in order to fill it. Thus, the time required for filling the dispenser 12 is greatly reduced. In addition, it is possible to fill the dispenser 12 above the level of the top of the second neck portion 18. Therefore, the check valve 58 allows the dispenser 12 to be filled with a greater quantity of liquid chemical. By filling the dispenser 12 with a greater quantity of liquid chemical, the dispenser 12 can be used for a longer period of time before another refill is necessary. Other check valve structures may be substituted for the particular structure shown in FIG. 6.

In the embodiment shown in FIG. 1, the containers 38, 40, 42 and the manifold 46 are mounted on a structure 44 that is mounted to a table 64. The containers 38, 40, 42 and manifold 46 could also be mounted, for example, on a wall, wheeled cart or any other suitable structure.

The materials of construction of the spray bottle dispenser 12, caps 26, 54 and snap in check valve 34 are well known and include, for example, polyethylene.

While the invention has been described with reference to certain preferred embodiments, numerous changes, alterations and modifications to the described embodiments are possible without departing from the spirit and scope of the invention, as defined in the appended claims and equivalents thereof.

What is claimed is:

1. An apparatus for filling spray bottle dispensers with liquid chemical, comprising:
a spray bottle dispenser, comprising
a bottle portion having a first and second neck portions and a liquid containing portion;
a sprayhead portion connected to the first neck portion;
a downtube connected to the sprayhead portion and extending into the liquid containing portion of the bottle portion;
a closure for opening and closing the second neck portion to allow the spray bottle dispenser to be filled through said second neck portion; and
a filling apparatus for filling the spray bottle dispenser with at least one liquid chemical, said filling apparatus configured for filling said spray bottle dispenser through said second neck portion of said spray bottle dispenser.

2. The apparatus of claim 1 wherein the sprayhead portion is removably connected to the first neck portion.

3. The apparatus of claim 1 wherein, when the spray bottle dispenser is in an upright position, the second neck is located vertically below the first neck portion.

4. The apparatus of claim 3 wherein, when the spray bottle dispenser is in the upright position, a longitudinal axis of the second neck portion is oriented substantially vertical.

5. The apparatus of claim 4 wherein the closure is a cap, the cap is internally threaded and the second neck portion is externally threaded such that the cap threadably engages the second neck portion.

6. The apparatus of claim 5 further comprising a check valve in the second neck portion.

7. The apparatus of claim I wherein the filling apparatus comprises at least one container containing the at least one type of premixed, ready-to-use liquid chemical.

8. The apparatus of claim 1 wherein the filling apparatus comprises:
a plurality of containers containing a plurality of chemical concentrates, respectively;
a water supply;
a manifold connected to the plurality of containers and the water supply, for mixing the chemical concentrates with water to obtain premixed ready-to-use liquid chemicals, the manifold including a shut-off valve for each container; and
flexible tubes connected to each shut-off valve.

9. The apparatus of claim 8 further comprising filler probes connected to each flexible tube.

10. The apparatus of claim 9 wherein the closure for opening and closing the second neck portion includes a check valve such that the spray bottle dispenser can be filled by inserting a filler probe through the check valve.

11. The apparatus of claim 8 wherein the filling apparatus is mounted on a wall.

12. The apparatus of claim 8 wherein the filling apparatus is mounted on a table.

13. The apparatus of claim 8 wherein the filling apparatus is mounted on a wheeled cart.

14. An apparatus for filling bottles with premixed, ready-to-use liquid chemical, comprising:
a spray bottle dispenser, comprising
a bottle portion having first and second neck portions and a liquid containing portion;
a sprayhead portion connected to the first neck portion;
a downtube connected to the sprayhead portion and extending into the liquid containing portion;
a closure for opening and closing the second neck portion; and
a source of premixed, ready-to-use liquid chemical for filling the spray bottle dispenser, said source configured for filling the spray bottle dispenser through the second neck portion.

15. The apparatus of claim 14 wherein the source of premixed, ready-to-use liquid chemical comprises:
a plurality of containers containing a plurality of chemical concentrates, respectively;
a water supply,
a manifold connected to the plurality of containers and the water supply, for mixing the chemical concentrates with water to obtain premixed ready-to-use liquid chemicals, the manifold including a shut-off valve for each container; and
flexible tubes connected to each shut-off valve.

16. The apparatus of claim 15 further comprising filler probes connected to each flexible tube.

17. The apparatus of claim 16 wherein the closure is a cap for opening and closing the second neck portion, said cap includes a check valve such that the spray bottle dispenser can be filled by inserting a filler probe through the check valve.

18. The apparatus of claim 14 wherein, when the spray bottle dispenser is in an upright position, a longitudinal axis of the second neck portion is oriented substantially vertical.

19. The apparatus of claim 18 wherein the closure is a cap, said cap is internally threaded and the second neck portion of the bottle portion is externally threaded such that the cap threadably engages the second neck portion.

20. The apparatus of claim 19 further comprising a check valve in the second neck portion.

21. An apparatus for filling spray bottle dispensers with premixed, ready-to-use liquid chemical, comprising:
a spray bottle dispenser, comprising
a spray bottle including first and second neck portions, the first neck portion being positioned above a bottle portion for containing a liquid;
a pump type sprayhead connected to the first neck portion;
a downtube connected to the sprayhead and extending into the bottle portion of the spray bottle;
a cap for closing the second neck portion; and
a filling apparatus for filling at least one type of premixed, ready-to-use liquid chemical in the spray bottle dispenser, said filling apparatus configured for filling the spray bottle dispenser through the second neck portion.

22. The apparatus of claim 21 wherein the filling apparatus comprises at least one container containing the at least one type of premixed, ready-to-use liquid chemical.

23. The apparatus of claim 22 wherein the means for supplying comprises:
a plurality of containers containing a plurality of chemical concentrates, respectively;
a water supply;
a manifold connected to the plurality of containers and the water supply, for mixing the chemical concentrates with water to obtain premixed ready-to-use liquid chemicals, the manifold including a shut-off valve for each container; and
flexible tubes connected to each shut-off valve.

24. The apparatus of claim 23 further comprising filler probes connected to each flexible tube.

25. The apparatus of claim 24 wherein the cap for closing the second neck portion includes a check valve such that the spray bottle dispenser can be filled by inserting a filler probe through the check valve.

26. The apparatus of claim 21 wherein, when the spray bottle dispenser is in an upright position, a longitudinal axis of the second neck is substantially vertical.

27. The apparatus of claim 26 wherein the cap is internally threaded and the second neck portion is externally threaded such that the cap threadably engages the second neck portion.

28. The apparatus of claim 27 further comprising a check valve in the second neck portion.

29. A method for filling a spray bottle dispenser with premixed, ready-to-use liquid chemical, comprising:
providing a spray bottle dispenser having first and second necks, a sprayhead connected to the first neck, and a cap for closing the second neck;
providing a supply of the premixed, ready-to-use liquid chemical;
dispensing the premixed, ready-to-use liquid chemical into the spray bottle dispenser via the second neck.

30. The method of claim 29 further comprising, after the dispensing step, the step of closing the second neck with the cap.

31. The method of claim 29 wherein the second neck includes a check valve.

32. The method of claim 29 wherein the providing step includes providing
a plurality of containers containing a plurality of chemical concentrates, respectively;
a water supply;
a manifold connected to the plurality of containers and the water supply, for mixing the chemical concentrates with water to obtain premixed ready-to-use liquid chemicals, the manifold including a shut-off valve for each container;
flexible tubes connected to each shut-off valve; and
filler probes connected to each flexible tube.

33. The method of claim 32 wherein the cap for closing the second neck includes a check valve and wherein the dispensing step includes inserting a filler probe through the check valve in the cap.

34. A method for filling a spray bottle dispenser with premixed, ready-to-use liquid chemical, comprising:
providing a spray bottle dispenser, the spray bottle dispenser comprising
a bottle portion having first and second neck portions and a liquid containing portion; a sprayhead portion connected to the first neck portion; a downtube connected to the sprayhead portion and extending into the liquid containing portion; and a cap for closing the second neck portion;
providing a supply of the premixed, ready-to-use liquid chemical;
dispensing the premixed, ready-to-use liquid chemical into the spray bottle dispenser via the second neck portion.

35. The method of claim 34 further comprising, after the dispensing step, the step of closing the second neck portion with the cap.

36. The method of claim 34 wherein the second neck portion includes a check valve.

37. The method of claim 34 wherein the providing step includes providing
a plurality of containers containing a plurality of chemical concentrates, respectively;
a water supply;
a manifold connected to the plurality of containers and the water supply, for mixing the chemical concentrates with water to obtain premixed ready-to-use liquid chemicals, the manifold including a shut-off valve for each container;
flexible tubes connected to each shut-off valve; and
filler probes connected to each flexible tube.

38. The method of claim 37 wherein the cap for closing the second neck portion includes a check valve and wherein the dispensing step includes inserting a filler probe through the check valve in the cap.
